(19) United States
(12) Patent Application Publication
(10) Pub. No.: US 2019/0255672 A1
(43) Pub. Date: Aug. 22, 2019

(54) WATER TEMPERATURE SETTING METHOD FOR PROCESSING APPARATUS

(71) Applicant: DISCO CORPORATION, Tokyo (JP)

(72) Inventors: Satoshi ARAI, Tokyo (JP); Jun SAITO, Tokyo (JP)

(21) Appl. No.: 16/277,405

(22) Filed: Feb. 15, 2019

(30) Foreign Application Priority Data
Feb. 20, 2018 (JP) 2018-027832

(51) Int. Cl. B23Q 11/14; B23Q 11/10

(52) U.S. Cl. CPC B23Q 11/146; B23Q 11/141; B23Q 11/1053

(57) ABSTRACT

A water temperature setting method for a processing apparatus for processing a workpiece held by a holding table by rotating at a high speed a spindle with a processing tool mounted thereto and supplying processing water to the processing tool. A set temperature for the processing water supplied to the processing tool is set to be higher than a set temperature for spindle cooling water supplied to a spindle unit that rotates the spindle at the high speed, in consideration of a lowering in temperature due to evaporation of the processing water scattered from the processing tool due to the high-speed rotation of the processing tool.

### BACKGROUND OF THE INVENTION

### Field of the Invention

The present invention relates to a method of setting a temperature of water supplied to each section of a processing apparatus.

### Description of the Related Art

A cutting apparatus for cutting a wafer held by a holding table by a cutting blade rotated at a high speed while supplying cutting water includes a spindle unit having a motor for rotating a spindle at a high speed. In addition, for preventing a trouble due to heat of the spindle unit or the like, a constant temperature water supplying apparatus is needed which includes a cooling water circuit for removing the heat generated by the motor and bringing the spindle unit to a set temperature and a cutting water circuit for supplying cutting water for cleaning and removing cutting swarf and for cooling the processing point to a cutting blade at a set temperature (see, for example, Japanese Patent Laid-open No. 2007-127343).

### SUMMARY OF THE INVENTION

The spindle unit includes a cooling jacket for removing the heat of the motor, and the cooling water circuit causes cooling water to flow in the cooling jacket, to remove the heat from the motor. Then, the cooling water raised in temperature by the heat of the motor is cooled by cooling means provided in the cooling water circuit, and is circulated in the cooling water circuit.

Since the cutting blade is rotated at high speed during cutting, the cutting water supplied to the cutting blade is scattered by centrifugal forces of the cutting blade, and is evaporated. Due to the heat of evaporation, heat is released from the cutting blade, and its temperature is lowered. For this reason, a temperature difference is generated between the spindle unit cooled by the cooling water through the cooling jacket and the cutting blade supplied with the cooling water and its surroundings, and thermal strain is generated in the spindle unit. This thermal strain influences adversely the processing of a wafer with a desired high accuracy.

It is therefore an object of the present invention to provide a temperature setting method for a processing apparatus by which generation of thermal strain in a spindle unit can be prevented, for performing desired processing of a workpiece such as a semiconductor wafer.

In accordance with an aspect of the present invention, there is provided a water temperature setting method for a processing apparatus that processes a workpiece held by a holding table by rotating at a high speed a spindle with a processing tool mounted thereto and supplying processing water to the processing tool, the water temperature setting method including setting a set temperature for the processing water supplied to the processing tool to be higher than a set temperature for spindle cooling water for cooling a spindle unit that rotates the spindle at the high speed, in consideration of a lowering in temperature due to evaporation of the processing water scattered from the processing tool due to the high-speed rotation of the processing tool.

According to the water temperature setting method for the processing apparatus of the present invention, in consideration of a lowering in temperature due to evaporation of the processing water scattered from the processing tool due to the high-speed rotation of the processing tool, the set temperature for the processing water supplied to the processing tool is set to be higher than the set temperature for the spindle cooling water for cooling the spindle unit that rotates the spindle at high speed. By this, a temperature difference is prevented from being generated between cooling by the cooling water and cooling by the cutting water, thermal strain can thereby be restrained from being generated in the spindle unit, and desired processing of the workpiece can be performed with high accuracy.

The above and other objects, features and advantages of the present invention and the manner of realizing them will become more apparent, and the invention itself will best be understood from a study of the following description and appended claim with reference to the attached drawings showing a preferred embodiment of the invention.

### BRIEF DESCRIPTION OF THE DRAWING

FIG. 1 is a schematic diagram depicting a cooling water circuit, a processing water circuit, and a spindle unit that constitute a processing apparatus.

### DETAILED DESCRIPTION OF THE PREFERRED EMBODIMENT

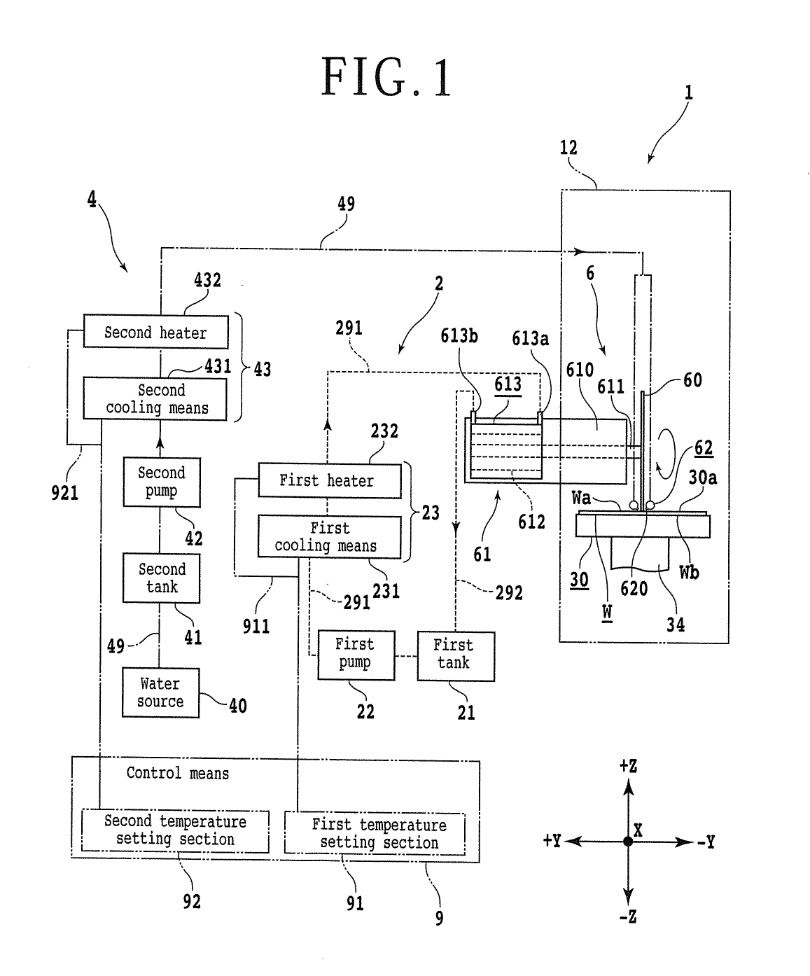

FIG. 1 is a schematic diagram depicting a structure of a cooling water circuit 2, a processing water circuit 4, and processing means 6 as components of a processing apparatus 1 to which a water temperature setting method according to the present invention is applied. Note that in the present embodiment, the processing apparatus 1 is a cutting apparatus that cuts a workpiece W suction held by a holding table 30 by a cutting blade 60 as a processing tool, but this is not limitative. The processing apparatus 1 may have any configuration insofar as it uses spindle cooling water supplied from the cooling water circuit 2 and processing water supplied from the processing water circuit 4; for example, the processing apparatus 1 may be a grinding apparatus or the like in which a grinding wheel is fixed to a tip portion of a spindle through a mount or the like.

The processing means 6 includes, for example, at least a spindle unit 61 provided with a spindle 611 driven to rotate, a processing tool 60 that is mounted to the tip of the spindle 611 and cuts the workpiece W, and a pair of processing water nozzles 62 that jet processing water to a contact part (processing point) between the processing tool 60 and the workpiece W. In addition, the processing means 6 can be put to indexing feeding in a Y-axis direction, and can be put to cutting-in feeding in a Z-axis direction.

As illustrated in FIG. 1, the spindle unit 61 has a spindle housing 610 extending horizontally in the Y-axis direction, and a spindle 611 having an axis in the Y-axis direction is rotatably accommodated in the spindle housing 610. A tip portion of the spindle 611 protrudes from the spindle housing 610 to a −Y direction side, and the processing tool 60 can be fixed thereto.

For example, to a rear end side of the spindle 611 in the spindle housing 610, a motor 612 for driving the spindle 611 to rotate is connected. The motor 612 includes, for example, a rotor mounted to the spindle 611, and a stator coil arranged on an outer periphery side of the rotor. With a voltage impressed on the stator coil, the rotor is rotated, to rotate the spindle 611 to which the rotor is mounted. To the outer periphery side of the stator coil of the motor 612, a cooling jacket 613 for surrounding a whole body of the motor 612 is mounted, for example. The cooling jacket 613 can cool the motor 612 surrounded thereby, through a process in which cooling water flowing in through a cooling water inlet 613a passes through a flow path formed inside the cooling jacket 613 and flows out through a cooling water outlet 613b. Note that the configurations of the motor 612 and the cooling jacket 613 are not limited to those in the present embodiment.

The processing tool 60 is, for example, a washer type cutting blade produced by binding diamond abrasive grains or the like with a binder such as a resin or a ceramic and molding the material into an annular shape, and is fixed to a tip portion of the spindle 611 by a mount flange (not depicted) or the like. Note that the processing tool 60 may be a hub blade which includes a metallic base formed in a disk shape, and a cutting blade fixed to an outer peripheral portion of the base.

The pair of processing water nozzles 62 extend in parallel to each other in an X-axis direction, in such a manner that a lower portion of the processing tool 60 is interposed therebetween. At those positions of the pair of processing water nozzles 62 which face lower portions of side surfaces of the processing tool 60, a plurality of jet ports 620 for jetting processing water are provided in the state of being aligned in the X-axis direction. Through the plurality of jet ports 620, the processing water is jetted from both sides in regard of the Y-axis direction toward a contact part between the processing tool 60 and the workpiece W, whereby cooling and cleaning of the contact part are performed.

The nozzles for supplying the processing water to the processing tool 60 are not limited to the pair of processing water nozzles 62, and processing water nozzles for supplying the processing water toward the processing tool 60 from the blade outer periphery direction of the processing tool 60 may further be disposed.

The holding table 30 having a circular external shape, for example, has a holding surface 30a which is formed from a porous material or the like and on which the workpiece W is suction held. A suction source (not depicted) such as a vacuum generating apparatus communicates with the holding surface 30a, and a suction force generated by an operation of the suction source is transmitted to the holding surface 30a on which the workpiece W is placed, whereby the holding table 30 can suction hold the workpiece W on the holding surface 30a. The holding table 30 can be rotated around an axis in the Z-axis direction by rotating means 34 disposed on the lower side thereof, and can be put to cutting feeding in the X-axis direction.

The processing apparatus 1 includes a processing chamber 12 by which the processing water supplied to the processing tool 60 and cutting swarf generated during cutting are prevented from scattering to the exterior of the apparatus. The whole part of the holding table 30 and part of the processing means 6 are accommodated in the processing chamber 12. The cooling water circuit 2 and the processing water circuit 4 are located outside the processing chamber 12. Note that the whole part of the processing means 6 may be accommodated in the processing chamber 12.

The processing water circuit 4 includes a water source 40 in which to reserve the processing water such as pure water, and the water source 40 communicates with the pair of processing water nozzles 62 through a processing water flow path 49 including a metallic piping and a flexible tube or the like, for example. A second tank 41, a second pump 42, and second temperature adjusting means 43 are sequentially disposed on the processing water flow path 49 in this order along a direction from the water source 40 toward the pair of processing water nozzles 62 on a downstream side.

The processing water supplied from the water source 40 is reserved in the second tank 41, and the processing water in the second tank 41 is fed from the second tank 41 to the pair of processing water nozzles 62 by the second pump 42. The processing water having been jetted from the pair of processing water nozzles 62 to cool and clean the contact part between the processing tool 60 and the workpiece W flows down from the area on the holding table 30 and is drained to the exterior of the processing chamber 12 through a water case (not depicted) and a drain pipe (not depicted) or the like.

The second temperature adjusting means 43 includes second cooling means 431 such as a chiller unit and a second heater 432. Cooling by the second cooling means 431 and heating by the second heater 432 are combined with each other, whereby the processing water is adjusted to a predetermined temperature.

The cooling water circuit 2 is a circuit in which spindle cooling water (hereinafter referred to as cooling water) is circulated. The cooling water circuit 2 includes a cooling water return path 292 providing communication between the cooling water outlet 613b of the cooling jacket 613 and a first tank 21 in which water is reserved, and a cooling water forward path 291 providing communication between the first tank 21 and the cooling water inlet 613a of the cooling jacket 613. The cooling water in the first tank 21 is sent toward the cooling jacket 613 by a first pump 22 disposed on the cooling water forward path 291.

First temperature adjusting means 23 is disposed on the downstream side of the first pump 22 on the cooling water forward path 291. The first temperature adjusting means 23 includes first cooling means 231 such as a chiller unit, and a first heater 232. Cooling by the first cooling means 231 and heating by the first heater 232 are combined with each other, whereby the cooling water is adjusted to a predetermined temperature.

The processing apparatus 1 includes control means 9 that includes a central processing unit (CPU) and a storage element such as a memory and the like and that supervisingly controls components of the processing apparatus 1. The control means 9 includes a first temperature setting section 91 and a second temperature setting section 92. The first temperature setting section 91 can output a control signal for temperature setting for the cooling water to the first temperature adjusting means 23 through a wireless or wired first communication path 911. The second temperature setting section 92 can output a control signal for temperature setting for the processing water to the second temperature adjusting means 43 through a wireless or wired second communication path 921.

A case where the workpiece W is cut by use of the processing apparatus 1 illustrated in FIG. 1 while performing the water temperature setting method of the present invention will be described below.

The workpiece W held by the holding table 30 is, for example, a semiconductor wafer having a disk-like external shape. A front surface Wa of the workpiece W oriented to the upper side is formed with a plurality of devices in regions portioned in a grid pattern by division lines (streets). A back surface Wb of the workpiece W is protected by a dicing tape (not depicted) adhered to thereto. Note that the workpiece W is not limited to the exemplary one illustrated in the present embodiment.

The workpiece W held by the holding table 30 is fed in a −X direction (toward the depth side of the paper surface), and the position of the division line into which the processing tool 60 is made to cut is detected. Thereafter, the processing means 6 is moved in the Y-axis direction, and alignment of the division line and the processing tool 60 in the Y-axis direction is performed.

The processing means 6 is lowered, for example, to a predetermined height position for fully cutting the workpiece W. In addition, the motor 612 rotates the spindle 611 at a high speed, and the processing tool 60 fixed to the spindle 611 is rotated at a high speed attendantly on the rotation of the spindle 611. Then, the holding table 30 is fed further in the −X direction at a predetermined cutting feeding speed, whereby the processing tool 60 is made to cut into the workpiece W, to cut the workpiece W along the division line.

For removing heat generated upon rotational driving of the spindle 611 by the motor 612 from the spindle unit 61, cooling water is passed in the cooling water circuit 2. Specifically, the cooling water is fed from the first tank 21 by the first pump 22. Besides, a control signal is outputted from the first temperature setting section 91 to the first temperature adjusting means 23, and temperature adjustment of the cooling water is conducted by the first temperature adjusting means 23 in such a manner that the cooling water flowing through the cooling water forward path 291 after passing through the first temperature adjusting means 23 is set to a predetermined set temperature T1 (for example, 22° C.). Therefore, the spindle unit 61 is cooled by the cooling jacket 613 through which the cooling water at the set temperature T1 passes. The cooling water having passed through the cooling jacket 613 has been warmed by absorbing the heat of the motor 612, and is returned to the first tank 21 through the cooling water return path 292. After returned to the first tank 21, the cooling water is fed out to the first temperature adjusting means 23 side by the first pump 22, and is cooled to the set temperature T1 by the first temperature adjusting means 23, whereby it is reused as cooling water for cooling the spindle unit 61.

During cutting, the processing water reserved in the second tank 41 is supplied through the processing water flow path 49 to the pair of processing water nozzle 62, and is jetted from the jet ports 620 of the pair of processing water nozzles 62 to the processing point (contact part) between the processing tool 60 and the workpiece W, thereby cooling and cleaning the processing point.

By centrifugal forces received from the processing tool 60 rotating at the high speed, the processing water supplied to the processing point is scattered, at the processing point or at a location spaced from the processing point by being carried together with the rotation of the processing tool 60, and is evaporated. When the processing water is evaporated, heat of the surface of the processing tool 60 in the processing chamber 12 is removed, resulting in cooling (for example, the temperature is lowered by 1° C. to 2° C.). Since the processing water upon removal of heat is drained to the exterior of the processing chamber 12, the inside of the processing chamber 12 is cooled together with the processing tool 60. If this results in generation of a temperature difference between that part of the spindle unit 61 which is located inside the processing chamber 12 and that part of the spindle unit 61 which is located outside the processing chamber 12 (the part cooled by the cooling jacket 613), thermal strain would be generated in the whole part of the spindle unit 61. Even in the case where the whole part of the spindle unit 61 is accommodated in the processing chamber 12, a temperature difference is generated between that part of the spindle unit 61 which is nearer to the processing tool 60 and that part which is near the motor 612 cooled by the cooling jacket 613, whereby thermal strain is generated in the whole part of the spindle unit 61.

In view of this, at the time of the supply of the processing water, the water temperature setting method according to the present invention is conducted, to adjust the temperature of the processing water. Specifically, in consideration of a lowering in temperature due to evaporation of the processing water attendant on the high-speed rotation of the processing tool 60, the set temperature for the processing water supplied to the processing tool 60 is adjusted to a predetermined temperature T2 which is 1° C. to 2° C. higher than the set temperature T1 for the spindle cooling water for cooling the spindle unit 61 that rotates the spindle 611 at a high speed. Specifically, in the present embodiment, a control signal is outputted from the second temperature setting section 92 to the second temperature adjusting means 43, and the temperature of the processing water is adjusted by the second temperature adjusting means 43 in such a manner that the processing water flowing through the processing water flow path 49 after passing through the second temperature adjusting means 43 is put to the predetermined set temperature T2 (for example, 24° C.). Note that the set temperature T2 may be 23° C.

As a result, even when the processing water at the set temperature T2 jetted from the jet ports 620 of the pair of processing water nozzles 62 to the processing point between the processing tool 60 and the workpiece W is evaporated and the temperature of that part of the spindle unit 61 which is located inside the processing chamber 12 is thereby lowered, little temperature difference would be generated between the inside part and that part of the spindle unit 61 which is located outside the processing chamber 12; therefore, thermal strain is prevented from being generated in the whole part of the spindle unit 61. Consequently, the workpiece W can be cut with high accuracy.

Note that the water temperature setting method according to the present invention is not limited to the above embodiment. The components of the processing apparatus 1 depicted in the attached drawing are not restricted to the illustrated ones, and appropriate modifications are possible within such ranges that the effect of the present invention can be produced.

The present invention is not limited to the details of the above described preferred embodiment. The scope of the invention is defined by the appended claim and all changes and modifications as fall within the equivalence of the scope of the claim are therefore to be embraced by the invention.

What is claimed is:

1. A water temperature setting method for a processing apparatus that processes a workpiece held by a holding table by rotating at a high speed a spindle with a processing tool mounted thereto and supplying processing water to the processing tool, the water temperature setting method comprising:
setting a set temperature for the processing water supplied to the processing tool to be higher than a set temperature for spindle cooling water for cooling a spindle unit that rotates the spindle at the high speed, in consideration of a lowering in temperature due to evaporation of the processing water scattered from the processing tool due to the high-speed rotation of the processing tool.
